(19) United States
(12) Patent Application Publication
(10) Pub. No.: US 2012/0098925 A1
(43) Pub. Date: Apr. 26, 2012

(54) PANORAMIC VIDEO WITH VIRTUAL PANNING CAPABILITY

(76) Inventors: Charles Dasher, Lawrenceville, GA (US); Bob Toxen, Duluth, GA (US); Bob Forsman, Sugar Hill, GA (US)

(21) Appl. No.: 12/909,189

(22) Filed: Oct. 21, 2010

(51) Int. Cl. H04N 7/00

(52) U.S. Cl. 348/36; 348/E07.001

(57) ABSTRACT

A plurality of cameras may be strategically placed around a venue for generating broadcast video streams which are processed by a broadcaster so as to produce a panning effect. A first video from one camera is streamed to one or more viewers. To create a panning effect, video from an adjacent, second, camera stream is used to interpolate video frames. The panning effect can be accomplished by interpolating frames for a certain number of time periods from a frame of the first camera and video frame of the second camera. The video from the first camera, the interpolated frames, and the video from the second camera is then selected and streamed to a viewer as a video stream, providing the panning effect. Multiple interpolation streams can be generated to handle panning from any camera to another camera. Panning requests may originate from the viewer or from the broadcaster.

### BACKGROUND OF THE INVENTION

The video viewing experience of viewers using a recorded medium, such as DVDs and Blu-ray™ video discs, has become more sophisticated. New recording technology offers the capability of storing multiple viewing angles of a particular scene. A viewer can view the same scene of a movie, but can select to see the same scene at different viewing angles. This encourages the viewer to view the movie multiple times, but with a slightly different viewing experience. This is accomplished by recording video from different angles, and allowing the viewer to select which camera feed is to be presented.

Cable service providers strive to also provide sophisticated and varied viewing experiences to their viewers. However, in most cases, the programming is predetermined and streamed to the viewer. For example, live sports broadcasting programs, such as that of a football game, select the viewing angle that is presented and streamed by the cable service provider to the viewer. The viewer presently is limited to the viewing angle that is streamed. In some embodiments, two channels can be streamed with different viewing angles, but the viewer must change channels to see a different angle. However, it is not always the case that the two video streams are timed exactly the same, and the transition between the two viewing angles is “jerky” and is not synchronized. Viewers would find it desirable to smoothly transition in real time from one viewing angle to another. Doing so with real-time broadcasting streams presents additional challenges which are not an issue for produced programs, such as those recorded on DVDs and other media.

Therefore, systems and methods are required for providing panning from one viewing angle to another, to viewers of live broadcast programs offered by a video service system.

### BRIEF SUMMARY OF THE INVENTION

In one embodiment, a system processes a first plurality of digital video frames and a second plurality of digital video frames for a video service provider to stream to a viewer comprising a composition module comprising a first buffer storing said first plurality of digital video frames associated with a first camera, a second buffer storing said second plurality of digital video frames associated with a second camera; and a processor configured to retrieve a first video frame from said first plurality of digital video frames, where said first video frame is associated with a first time period, retrieve a second video frame from said second plurality of digital video frames, wherein said second video frame is associated with a second time period, wherein said second time period is subsequent to said first time period, wherein there are at least one or more intervening time periods between said first video frame and said second video frame, process said first video frame and said second video frame so as to produce one or more interpolated video frames, store said one or more interpolated video frames into a panning video buffer, and cause said first video frame, said one or more interpolated video frames, and said second video frame to be streamed the sequence to said viewer of said video service provider.

In another embodiment of the invention, a method processes a first plurality of digital video frames and a second plurality of digital video frames comprising the steps of receiving said first plurality of digital video frames at a composition module associated with a first camera, receiving said second plurality of digital video frames at the composition module associated with a second camera, selecting a first video frame from said first plurality of digital video frames wherein said first video frame is associated with a first time period, selecting a second frame from said second plurality of digital video frames, wherein said second frame is associated with a second time period, wherein said second time period is subsequent to said first time period, processing said first frame and said second frame by a processor in said composition module to generate one or more interpolated video frames, storing said interpolated video frames into a panning video buffer, and causing streaming in sequence of said first video frame, said one or more interpolated video frames, and said second video frame to be streamed over a cable distribution network.

In another embodiment of the invention, a system provides panning video frames to a viewer comprising a first memory buffer storing first MPEG video frames from a first camera, said first MPEG frames comprising a first plurality of first video frames wherein each one of said first video frames is associated with a respective time period, a second memory buffer storing MPEG video frames from a second camera, said second MPEG frames comprising a second plurality of second video frames wherein each one of said second video frames is associated with said respective time period, a processor configured to retrieve one of the first plurality of first video frames from said first memory buffer as an originating video frame, retrieve one of the second plurality of second video frames from said second memory buffer as a target video frame, wherein said originating video frame is associated with a time period X and said target video frame is associated with a time period Y, wherein time period Y occurs Z number of time periods after time period X, and generate Z−1 number of interpolated video frames based on said originating video frame and said target video frame, and a video pump configured to stream said originating video frame, said Z−1 number of interpolated video frames, and said target video frame to a viewer.

The above represents only three embodiments of the invention and is not intended to otherwise limit the scope of the invention as claimed herein.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates various images associated with two cameras providing video images at a venue;

FIG. 2 illustrates one embodiment of using multiple camera images to produce a panning video stream to viewers;

FIG. 3 illustrates a frame map of video frames generated by a plurality of cameras;

FIGS. 4a-4b illustrate a frame map of video frames used to provide a panning video stream;

FIG. 5 illustrates another embodiment of providing a panning video stream;

FIGS. 6a-FIG. 6c and FIG. 7 illustrate embodiments for providing interpolated video frames;

FIGS. 8-9 illustrate frame maps for providing a plurality of interpolated video frames;

FIG. 10 illustrates another embodiment of a system for providing a panning video stream to a viewer;

FIG. 11 illustrates a process for controlling a panning video stream to a viewer; and

FIG. 12 illustrates one embodiment of a composition module.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

Although certain methods, apparatus, systems, and articles of manufacture have been described herein, the scope of coverage of this patent is not limited thereto. To the contrary, various embodiments encompass various apparatus, systems, and articles of manufacture fairly falling within the scope of the appended claims either literally or under the doctrine of equivalents.

As should be appreciated, the embodiments may be implemented in various ways, including as methods, apparatus, systems, or computer program products. Accordingly, the embodiments may take the form of an entirely hardware embodiment or an embodiment in which computing hardware, such as a processor or other special purpose devices, is programmed to perform certain steps. Furthermore, the various implementations may take the form of a computer program product on a computer-readable storage medium having computer-readable program instructions embodied in the storage medium. Any suitable computer-readable storage medium may be utilized including, but not limited to: technology based on hard disks, CD-ROMs, optical storage devices, solid state storage or magnetic storage devices.

The embodiments are described below with reference to block diagrams and flowchart illustrations of methods performed using computer hardware, apparatus, systems, and computer-readable program products. It should be understood that the block diagrams and flowchart illustrations, respectively, may be implemented in part by a processor executing computer-readable program instructions, e.g., as logical steps or operations executing on a processor in a computing system or other computing hardware components. These computer-readable program instructions are loaded onto a computer, such as a special purpose computer or other programmable data processing apparatus, to produce a specifically-configured machine, such that the instructions which execute on the computer or other programmable data processing apparatus implement the functions specified in the flowchart block or blocks.

### Service Overview

In one embodiment of the present invention, subscribers of a video service provider are offered the ability to control the viewing camera angle of a broadcast program in a seamless manner. For purposes of illustration of the invention, the broadcast program is a sports-oriented broadcast of a live event, specifically in one embodiment, a football game, but the principles of the invention can readily apply to other types of programs, whether they are broadcasts of other types of sports or other types of programs. Further, the video service provider is illustrated herein as a cable service provider (“CSP”) although the principles of the invention can be applied to other types of service providers, using a variety of transport technologies, including wireless architectures, satellite television communications, IP based communications, hybrid-fiber coax architectures, etc.

The term “pan” or “panning” as applied to cinematography refers to a sweeping movement of the camera angle. One form of panning can refer to physically rotating the camera on its vertical axis (referred to herein as “rotational panning” herein) and another form can refer to a horizontal movement of the camera (called “horizontal panning” herein). Unless explicitly indicated otherwise, “pan” or “panning” refers to “horizontal panning” for reasons that will become clear.

Broadcasting a sporting event, such as a football game can be challenging because the play on the field can rapidly shift from one area of the field to another. Some venues incorporate an arrangement of a series of wires and motorized pulleys to move a camera along the playing field (specifically, to perform a horizontal pan). It can be impractical or expensive to set up the infrastructure to perform such a horizontal pan. Further, it may not provide the desired perspective. Consequently, rotational panning combined with zooming is often used to provide video of the action on the field. However, zooming does not always allow a clear view of the play. Further, as the camera is rotated, the viewing angle is increased. Typically, a broadcaster televising an event such as a football game will deploy multiple cameras to provide various viewing angles in the venue (e.g., a football stadium).

Thus, broadcasters typically deploy a number of cameras at regular locations to provide a number of angles of the field of play. Each camera provides a different perspective and generates digital data or a “camera feed” of video. The digital data generated may comprise MPEG frames, or it may be processed into a particular version of MPEG based frames. Typically, the video feeds are sent to a control/editing booth. There, the videos from each camera feed are displayed and the broadcaster can select which angle will be presented. This is accomplished by switching the desired camera feed to produce the final television signal of the event that is then provided to various video service providers. Thus, the angle of view (or camera feed) is controlled by the broadcaster.

With the advent of more powerful and less expensive processing equipment, it is possible to process the videos from adjacent camera to produce a virtual panning effect. Further, with the advent of higher bandwidth and lower cost communication facilities, it is now feasible and economical to broadcast multiple video streams (each associated with a camera) to the video service provider and they can process the videos to provide a virtual panning effect. In other embodiments, the user may be able to control the virtual panning stream. In other words, rather than the broadcaster making the selection of the appropriate camera feed in the control booth and streaming a panning video stream to the viewer, the broadcaster can provide a plurality of video feeds and allow the cable service provider to control the camera angle to accomplish panning. The cable service provider may, in turn, allow the subscriber to control the panning.

In one embodiment, the commands are received that indicate which angle is displayed in real-time. This indication can originate from the user manipulating the remote control in a specified manner. For example, a software application program can be downloaded to the set top box, which when executed, causes the procedures described below to be initiated in the cable headend. In another embodiment, the broadcaster can originate the indications to provide a virtual panning effect. In yet another embodiment, the broadcaster may replace or supplement the panning arrangement using the suspended cables and motorized platform and replace this with virtual panning relying on multiple cameras.

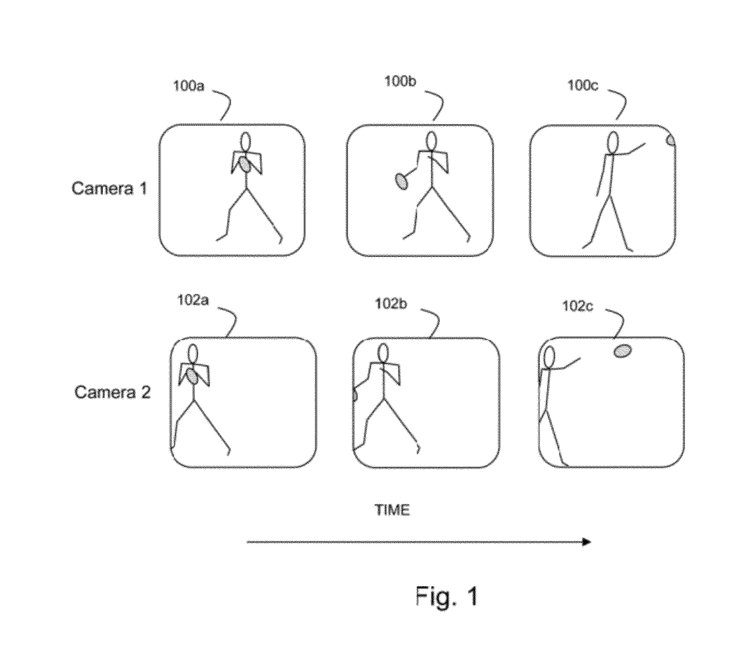

FIG. 1 illustrates the concept of multiple cameras positioned to provide slightly different perspectives on the same subject matter. In FIG. 1, various frames from a television broadcast are depicted capturing subject matter, but from two different cameras. These are referred to as Camera 1 (“C1”) and Camera 2 (“C2”). These cameras provide simultaneous digital video frames on a periodic basis, typically in a MPEG based format. For purpose of illustration, it is assumed that the video frames generated by the cameras are synchronized, so that in FIG. 1, frame 100a from C1 is generated at the same time as frame 102a from C2. If the images were not synchronized, this could be easily accomplished by buffering one of the streams so as to provide synchronization. Further, although FIG. 1 can be considered as a series of images on a display device (e.g., a television), FIG. 1 could have also been alternatively depicted as a series of MPEG data frames or packets, but it is easier to illustrate the principles of the invention by referring to images, which are conveyed by the MPEG data frames. Thus, there is a somewhat equivalence between the image and the video frame (a.k.a. “frame”) which conveys that image.

In FIG. 1, frames 100a and 102a both depict the same subject matter (i.e., the quarterback in a football game, preparing to throw the football), but the cameras are positioned at different locations. Thus, in image 100a, the subject is slightly to the right of center, whereas in image 102a the same subject is left of center. This same perspective is reflected in images 100b and 102b, as well as the third consecutive frames of the two cameras 100c and 102c. In this embodiment, there is some overlap of the subject matter depicted in each image from the different cameras for a given time period.

As noted, the broadcaster typically will have a control booth with an editor controlling which video feed is selected as the source for the real-time broadcast. Examination of FIG. 1 suggests that images 100a and 100b have the main subject centered in the image, but by the subject matter moves over time and by the third frame (100c) the focus on the ball, has left the image. Thus, in an ideal situation, the controller would at this point have selected image 102c from camera 2 in time in order to maintain the focus on the desired subject matter.

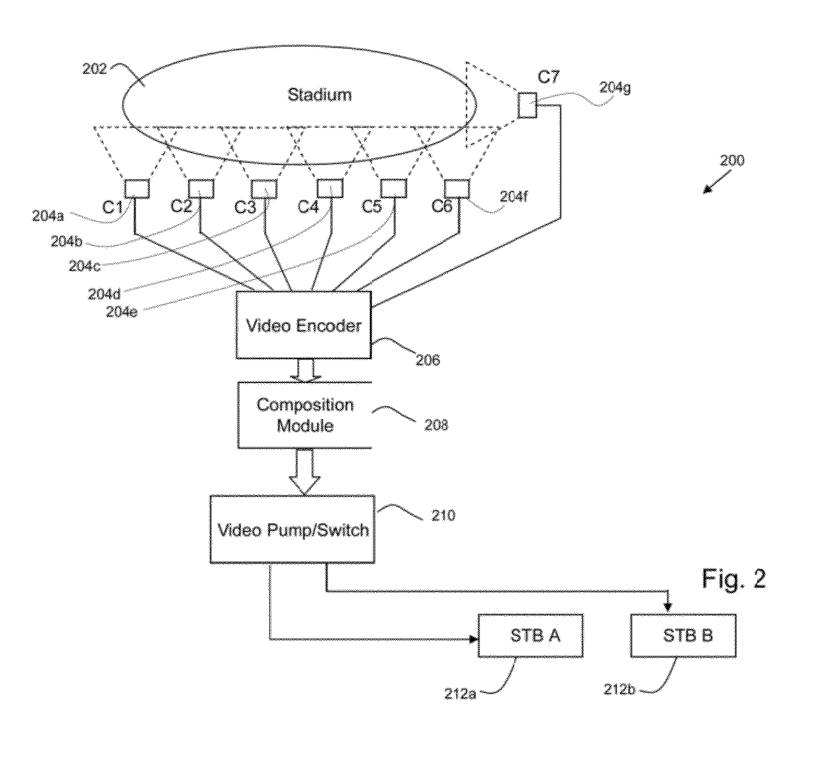

The illustration of FIG. 1 depicts two cameras that focus on a field of play. The use of multiple cameras could be extended so that many more cameras line the field of play. Typically, these are placed at regular intervals so that complete coverage of the field of play is obtained. Thus, for a football field, cameras could be deployed every 5 or 10 yards. As the price of cameras declines, the cost of deploying multiple cameras becomes less expensive. One such embodiment of deploying multiple cameras is illustrated in FIG. 2.

### System Architecture

In FIG. 2, the system 200 comprises a plurality of cameras Camera 1 (“C1”)-Camera 7 (“C7”) 204a-204g. Cameras C1-C6 are positioned along a line along the playing field, and in many embodiments the plurality of cameras will be linearly positioned. However, in other embodiments, the cameras may be positioned “off the line” or at an angle, which is shown by C7 204g. Camera C7 depicts an end-of-field view, which is perpendicular to the line of the other cameras. As will be seen, changing the perspective from, e.g., camera 6 to camera 7 can be considered a special type of panning, which can be called “angular panning” herein. As used henceforth, “panning” encompasses both horizontal and angular panning. For purpose of illustrating the principles of the invention, panning will be mainly limited to changing angles from one of the linearly positioned cameras, C1-C6. However, as will be seen, it is possible to adjust the angle from, e.g., camera 6 to camera 7.

In the embodiment shown in FIG. 2, the field of the view captured by the cameras 204a-g overlaps to some extent. Overlapping the field of view of the cameras is not required in all embodiments, but doing so can facilitate the interpolation process when images of adjacent cameras are interpolated. Thus, in one embodiment, a portion of the image (subject matter) captured by the nth camera is found in the image of the n−1 and the n+1 camera. Specifically, for example, returning to FIG. 1, the forearm of the quarterback in FIG. 100c of camera 1 is also contained in the image of the adjacent camera in FIG. 102c. Since the images are synchronized in time, the relative position of the quarterback's forearm will be similar in images 100c as in 102c.

The plurality of cameras can be arranged differently at the venue, and a different number could be present than illustrated in FIG. 2. Each camera provides a digital stream of data to a video encoder 206. The video encoder typically formats the data into a standard format (if it not already is in the desired format). In one embodiment, the digital data is based on the MPEG encoding standard. MPEG will be used as an encoding scheme to illustrate the principles of the invention, but the invention can be used for other encoding schemes and the claims are not limited to using MPEG unless expressly limited thereto. Thus, the video encoder has a plurality of inputs and provides a corresponding number of outputs. In this depiction, each of the cameras has a separate connection into the video encoder, but a single output multiplexes the plurality of video streams on a single facility.

The plurality of video streams are provided to the composition module, which processes the streams accordingly. The composition module may receive commands for panning, and select the appropriate stream. These commands may originate from the broadcaster, the video service provider, a subscriber, or some other source. The composition module may also interpolate the digital images that are to be streamed to form the virtual panning video stream. In one embodiment the composition module is centrally controlled for providing a panned image as a general broadcast feed to a video service provider. In another embodiment, the composition module receives user commands and generates a unicast broadcast feed for a particular user. In this later case, the composition module may be located within a video service provider. Thus, processing of the input feeds may be done by different entities and at different downstream locations. By locating the processing further downstream (e.g., towards the consumer of the video), it is easier to provide a customized video stream for that subscriber.

The composition module 208 may generate a number of output streams. For example, a number of subscribers may be afforded the capability of receiving a custom video stream wherein they control the panning. Thus, each stream is a real-time stream of the sporting event, but the separate viewers may have different unicast streams provided to them. The composition module 208 is shown as providing a plurality of multiplexed streams to the video pump 210. The video pump can comprise a headend multiplexer for grooming and streaming the appropriate video streams and provides the streams onto the cable distribution network. The streams are then transmitted o the viewers via Set Top Box (“STB”) A 212a and STB B 212b. In other embodiments, a single output from the composition module may be provided.

In the present embodiment, the video encoder module 206 provides a plurality of MPEG video streams. The MPEG video stream can be, e.g., an elementary, stream or a transport stream, but in either case it is typically identified by a 13 bit packet ID or PID. The PID identifies the separate video images when multiplexed on a common facility. Thus, the output of video encoder module 206 can provide multiple MPEG streams on a single facility, with each stream identified by a PID. Hence, reference to a particular PID is a reference to a particular stream of video frames.

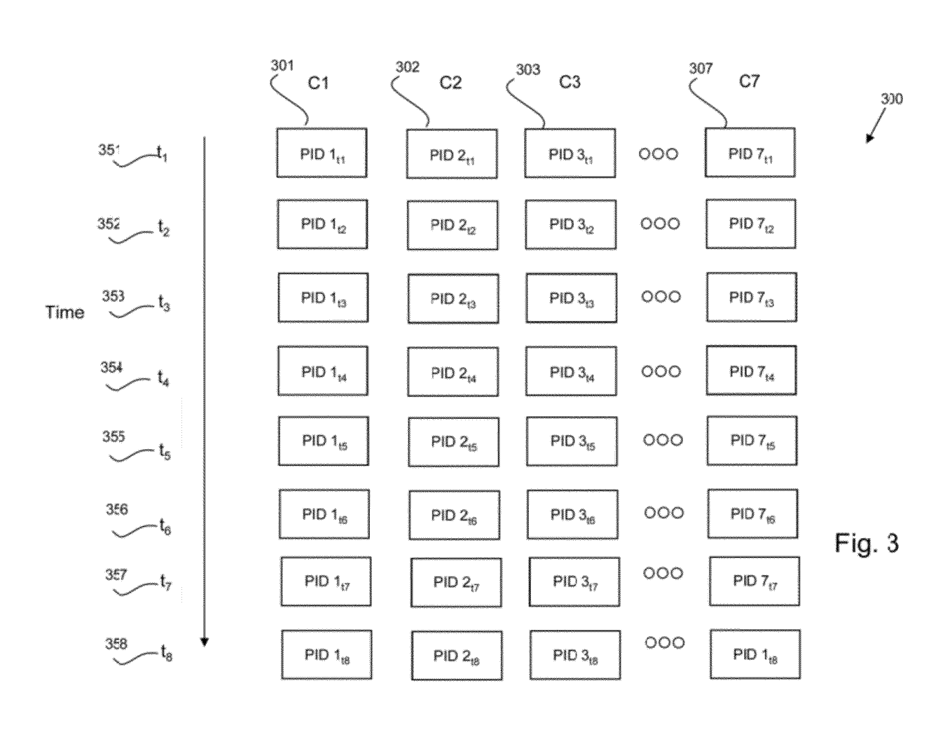

FIG. 3 depicts a “frame map”, which are the video frames generated by each camera, C1-C7 shown in FIG. 2. Recall that other embodiments may have a different number of cameras, such as 100 cameras. However seven cameras are used to illustrate the principles of the present invention. In this embodiment, each camera produces digital data which is the basis of the MPEG packets which convey frames. For purposes of convenience, each box (e.g., 301) illustrated can be presumed to represent a frame or an image produced by the respective camera. A MPEG packet is 188 bytes in length, and multiple packets are required to construct a frame, but they have the same PID. For purposes of simplicity and illustration of the principles of the present invention, the terms “frame,” “packet,” and “image” conceptually refer to a screen image and are used interchangeably. As noted before, other encoding standards can be used in application of the inventive principles, such as MP4 based encoding, the Ogg standard (which is an open standard container format maintained by the Xiph.Org Foundation), proprietary encoding techniques, etc.

The columns in FIG. 3 represent images from the camera as indicated at the top of the column. For reference purposes, the boxes (representing a video frame) are referred to using the nomenclature of “PID Xt_{y}.” The “X” represents the camera number and the “y” represents the time period. Thus, PID 2t₁ (labeled by reference number 302 in FIG. 3) represents the image identified by Packet ID from camera 2 for time period 1. Reference to frames will be made herein in this manner.

As shown in FIG. 3, time is progressing in a downward direction, so that time period t₁ 351 is followed by t₂ 352, etc., down to time period t₈ 358 at the bottom of FIG. 3. The time periods extend across the rows, such as PID 1t₁ is generated in the first time period, as is PID 2t₁, PID 3t₁ . . . and PID 7t₁. In summary, the field of PIDs in FIG. 3 depicts the various data generated by seven cameras over eight time periods.

Conceptually, the composition module 208 receives these seven streams, and generates the appropriate output streams in real time. Practically, the composition module receives the above streams and buffers a number of PIDs from each camera in memory. This is required, as will be seen, in order to generate the series of interpolated video frames for a user. Because the interpolated video frames represent a virtual panning, they are also sometimes referred to herein as the panning video frames Although buffering introduces some delay into the processing of real-time video, the delay is relatively little so that the resulting output can still be considered as a real-time broadcast stream.

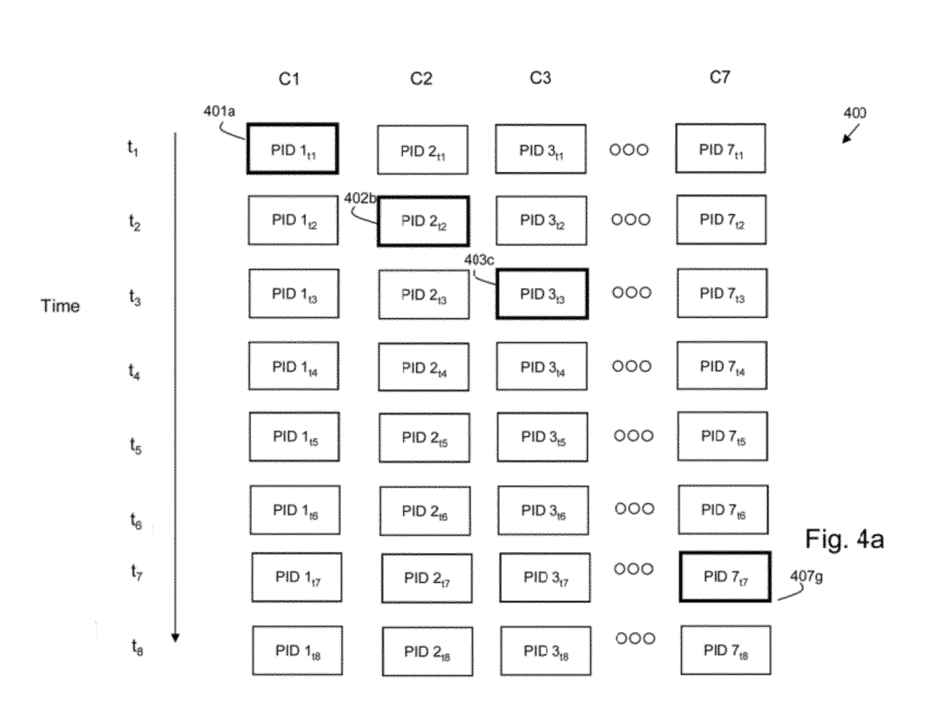

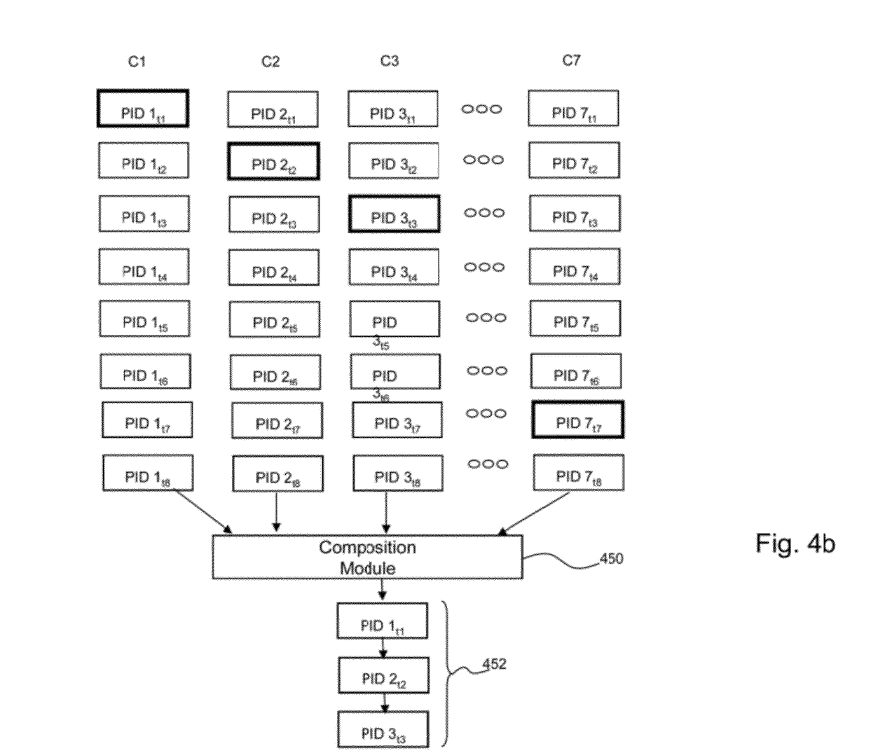

FIG. 4 illustrates one embodiment of the invention for providing a panning video stream. In this embodiment, the frame map highlights certain frames for selection, which produces a “staircase” profile. This approach involves selecting sequentially generated frames from sequentially located cameras to stitch together a digital video stream. In this embodiment, the staircase approach does not involve processing digital data to interpolate frames. In FIG. 4, certain frames are highlighted. Specifically, PID 1ₜ₁, PID 2ₜ₂, PID 3ₜ₃ . . . PID 7ₜ₇ are shown in bold. These images represent the first image 401a from camera 1 during the first time period, the next image 402b from camera 2, the next image 403c from camera 3, and so forth. Thus, selection of these frames mimics a “staircase” profile.

Each of the streams from each camera are provided to the composition module. The composition module 450 as shown in FIG. 4b selects the appropriate image, from the appropriate input stream, at the appropriate time, to output to the video pump. The output is shown in FIG. 4b as the sequential frames 452, comprising PID 1ₜ₁, PID 2ₜ₂, PID 3ₜ₃ . . . . Thus, selection and presentation of these images to a user represents a virtual panning of the subject matter. Note that this is accomplished by selecting images at different points in time from different cameras, as opposed to physically moving the location of the initial camera. In this embodiment, there is no interpolation of frames, but only selection of unmodified frames from each camera.

The sequences of frames produced by MPEG corresponds to roughly 30 frames per second, or 1/30^{th} of a second per frame. Thus, the staircase profile shown in FIG. 4a corresponds to switching from one camera feed to another camera once every frame, or 1/30^{th} of a second. To pan from the image on camera 1 to camera 7 as shown in FIG. 4a therefore requires 6 frame-times, or 6* 1/30^{th} of a second, which is ⅕ of a second. Obviously as the number of cameras increases, the longer it takes to pan across the subject matter of the cameras, assuming that every sequential camera is selected for a frame. If a faster pan is desired, one or more cameras could be skipped. For example, selecting a first frame from camera 1, a second frame from camera 3, a third frame from camera 5, etc. will accomplish a faster pan by skipping over certain camera feeds.

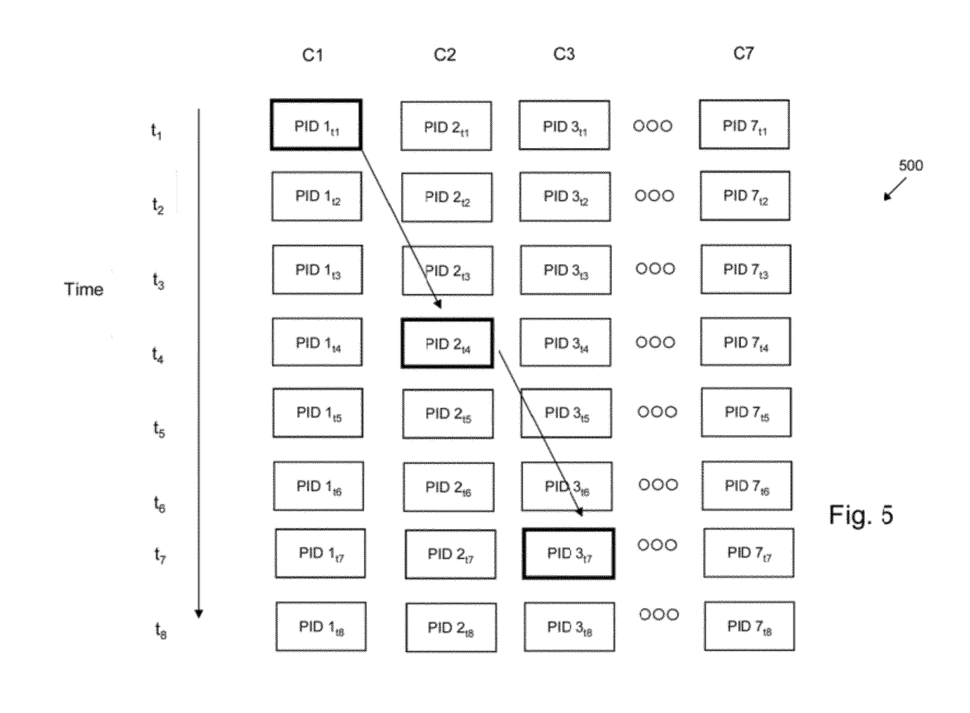

In other embodiments, it maybe desirable to pan slower across the subject matter. This can be accomplished by selecting the subset of frames as shown frame map 500 in FIG. 5. In this embodiment, the initial frame is PID 1ₜ₁ which is held static (or repeated) for two additional time periods. In other words, the image of PID 1ₜ₁ can be duplicated for a total of three time periods at the output of the composition module. Then, in the fourth time period, the composition module selects PID 2ₜ₂, and that image is held static for two additional time periods, and so forth. This has the effect of panning in a slower manner from one camera to the next camera. Thus, a slow motion effect can be generated.

One disadvantage of panning slower as described above is that by replicating a frame two or three (or more) times and then selecting the next frame from another camera, the field of action may have changed such that the image presented to the viewer appears “jerky” or discontinuous. For example, as shown in FIG. 1, replicating camera 1's image 100a for two frames, and then presenting camera 2's frame 102c would represent a discontinuity. Depending on the speed, this may be perceived by the viewer.

This leads to another embodiment of the invention. In this embodiment, the transition from one frame to another frame involves processing the frames to produce interpolation frames. Recall that in FIG. 5 a sequence of frames are selected and displayed. MPEG requires transmission of frames at a periodic rate, so it is not possible to slow down the panning merely by slowing down the transmission of data. As discussed in FIG. 5, a frame could be replicated a certain number of times before the next camera feed is selected to produce a slower panning effect, but this results in a jerky transition.

In this embodiment, interpolation software is used in the composition module to transition from one frame to another. Returning to the field map of FIG. 5, for purposes of illustration, PID 1ₜ₁ will be referred to as the originating video frame and PID 2ₜ₄ will be referred to as the target video frame. It is possible to transition from the originating video frame (PID 1ₜ₁) to the target video frame (PID 2ₜ₄) by over four time periods without replicating the originating video frame during t₂ and t₃. This is accomplished by interpolation processing to transition from the originating video frame to the target video frame. Once this is accomplished for interpolating from PID 1ₜ₁ to PID 2ₜ₄, the process is repeated but PID 2ₜ₄ is now the originating video frame and PID 3ₜ₇ is the target video frame, and so forth.

Returning to FIG. 5, the originating video frame is PID 1ₜ₁ is displayed during time period t₁, and the target video frame is displayed in time period t₄. This means that interpolated video frames should be generated for t₂ and t₃. In one embodiment, a single interpolated video frame could be duplicated for these two time periods, but in other embodiments, two distinct video frames will be generated—one for t₂ and another for t₃.

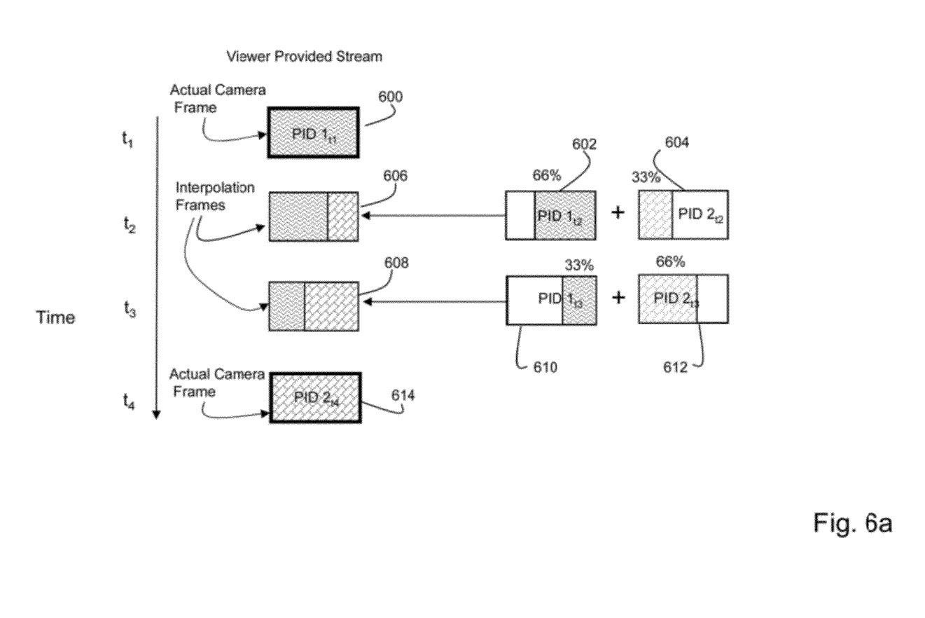

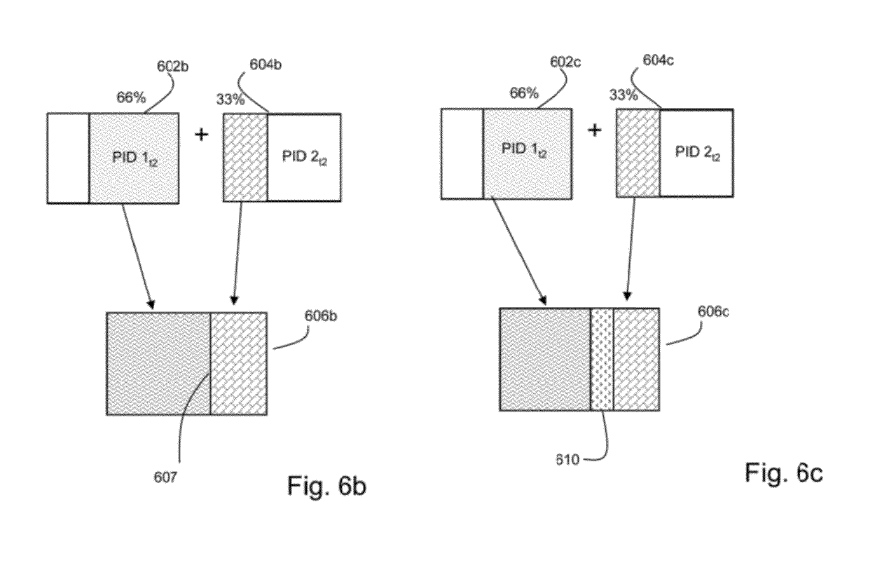

FIG. 6 illustrates one embodiment of generating such interpolation or transition frames. The column of video frames labeled as 600, 606, 608, and 614 represent the output of the composition module (similar to the frames 452 from FIG. 4b). The frames are sequentially generated by the composition module at periodic intervals, corresponding to time periods t₁, t₂, t₃, and t₄. The first frame 600 corresponds to the PID from camera 1 during the first time period and the last frame shown 614 corresponds to the PID from camera 2 during the fourth time period. These frames represent unmodified frames generated from the camera, as opposed to frames which are interpolated. Frames 606 and 608 are interpolated frames, and are generated by the composition module. These frames represent composite frames based on the originating and target video frames.

One algorithm for generating the interpolated frames is shown diagrammatically via frames 602, 604, 610, and 612 in FIG. 6a. This can be described as an approach of transforming the originating video frame to the target video frame by gradually changing or incorporating the contents of the originating and target frames. First, frames 602 and 604 are discussed. These two frames represent portions of the originating video frame and the target video frame. Specifically, as shown in FIG. 6b, frame 602b is based on PID 1ₜ₁ but only 66% of the content is used to generate the interpolation frame 606b. Specifically, the 66% of the right most content is used, as the panning is to the right (towards camera 2). The remaining 33% is obtained from the leftmost content of the target video frame, shown here as frame 604b, which is from camera 2. Returning to FIG. 6a, in the next interpolated frame 608, less of the originating video frame is used while a greater percentage of the target video frame is used. Specifically, only 33% of the originating frame is used and 66% of the target video frame is used. This makes up frame 608. Thus, the sequence of frames start out with frame 600 that is an unmodified camera frame, and gradually phases out the image of the originating video frame and incorporates more and more of the target video frame until the target video frame 614 is achieved, which is 100% of the unmodified frame from the next camera.

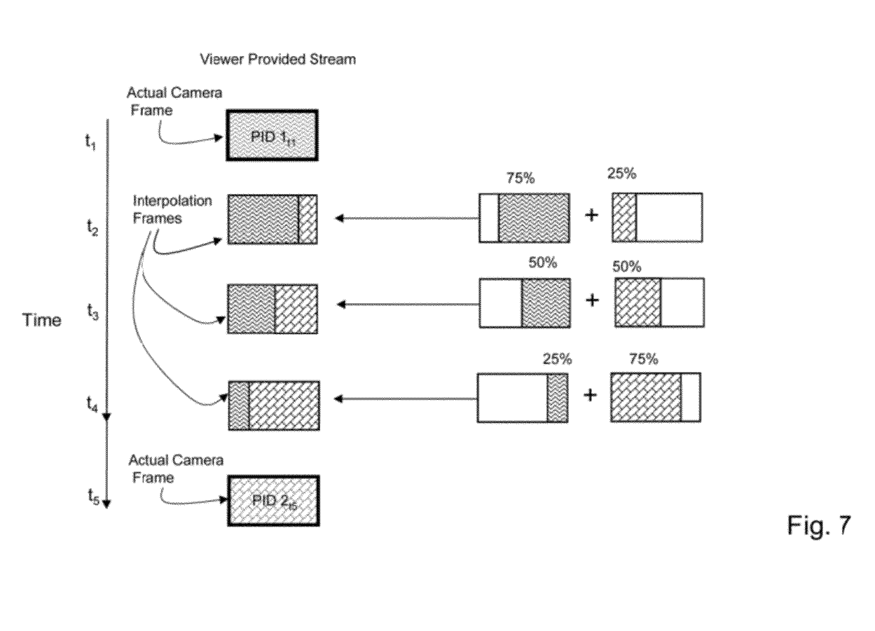

Using a greater number of transitional frames will improve the visual result, as shown in FIG. 7. FIG. 7 illustrates another embodiment where three interpolation frames are generated, and each intermediate frame incorporates 25% more of the target video frame. Thus, the division is 25/75, followed by 50/50, and then by 75/25. This represents a more gradual transition to the target video frame. Thus, to achieve a slower pan from one camera to another, the percentage change for each time period can be made less and less. For example, incrementing changes by 10% would result in nine intermediate interpolation frames, which would consume 10/30 of a second when panning from one camera to another.

Those skilled in the art will recognize that a number of processing algorithms can be used to transform a starting image to an ending image. The above simplistic example is based on selecting a portion of the image and combining it with another portion of another image to generate interpolated frames without any further processing. For illustration purposes above, the point of demarcation is rather abrupt between the two portions of an interpolation frames. Specifically, in FIG. 6b the demarcation line 607 is distinctly present, as the two video portions are simply chopped and then concatenated. This type of melding of the two images is simplified to illustrate the principles of the invention, but in other embodiments, more sophisticated algorithms can be employed to smooth the transition between the boundaries of the melded content in the interpolation frames. For example, in FIG. 6c a more sophisticated transforming algorithm can be used such that a transition portion 610 is generated to “smooth” the transition between the two images used to form the transitional frame.

There is a tradeoff between processing power required and the number of cameras. If there were a large number of cameras, the need for such interpolation processing is reduced and panning could be potentially accomplished by merely performing a staircase type of selection of camera inputs. However, adding a large number of cameras to the field of play can become more expensive in its own right and performing interpolation may provide added flexibility.

The approach from transitioning from the originating video frame to the target video frame as described above substitutes a portion of an image with another image. Other techniques can be used for transitioning from one image to another, and a number of software packages are readily available on the market for accomplishing these special effects. These packages are sometimes referred to as “morphing software.” Thus, a variety of techniques for morphing the originating video image to the target video image over the required number of time periods can be used. It is required that the process complete the appropriate number of interpolation frames in the required time, because as noted, MPEG requires 30 frames to be provided every second.

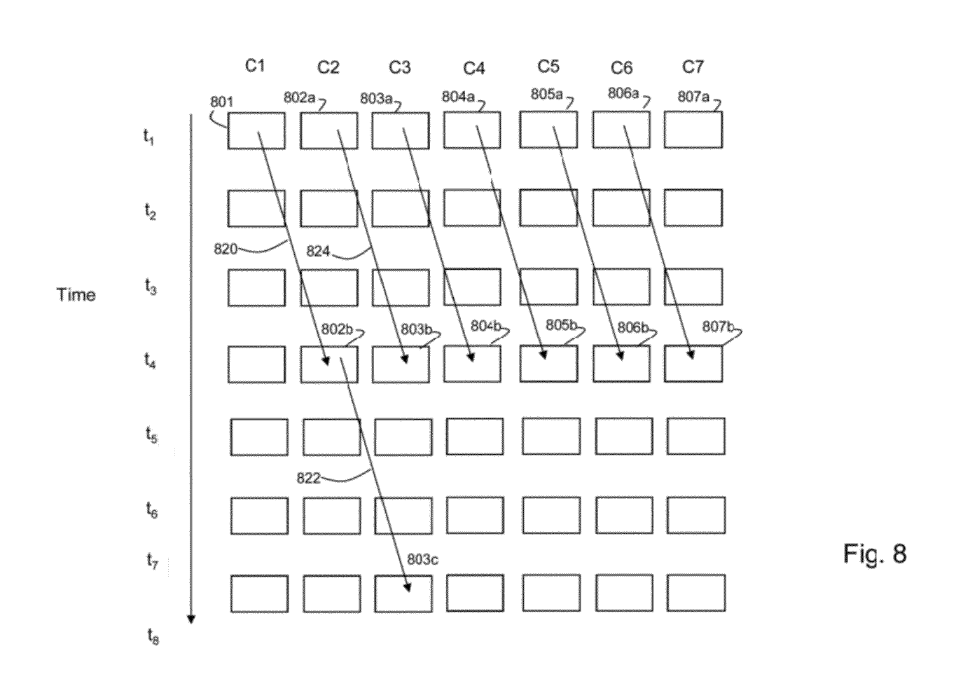

To recap and referring to FIG. 5, a subscriber may be viewing frame PID generated by camera 1 at t₁. A panning effect may be provided to that subscriber by identifying a target video frame on camera 3, which is PID 3ₜ₇. This can be accomplished by morphing the originating frame to the PID 1ₜ₁ over a series of four time periods resulting in PID 2ₜ₄. Then PID 2ₜ₄ can be morphed over four time periods to PID 3ₜ₇. This is the same transition as shown in FIG. 8 involving lines 820 and lines 822.

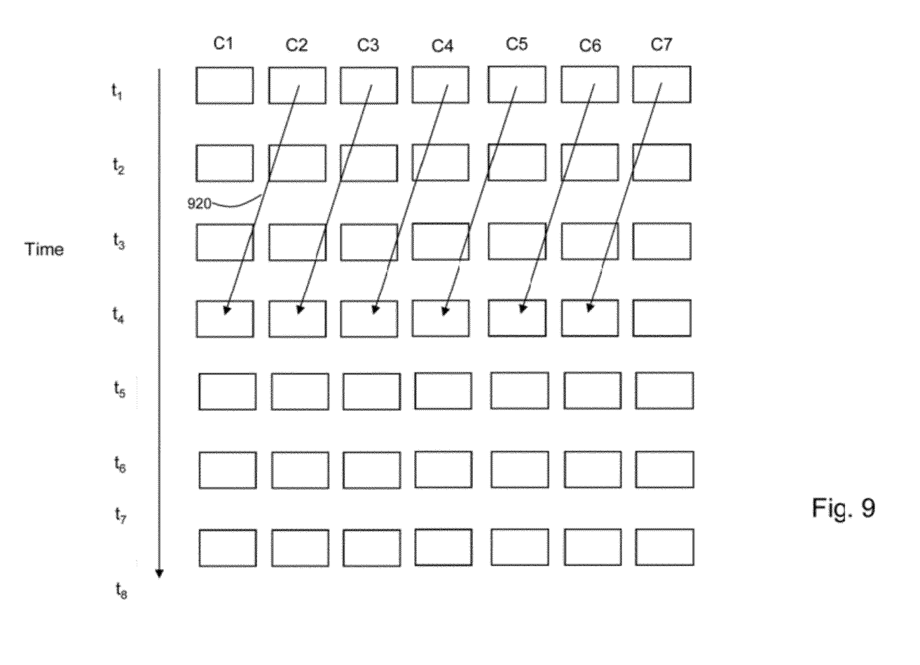

Focusing on FIG. 8, it is quite possible that another subscriber may be provided with a different panning effect. For example, at the same time while the aforementioned subscriber is viewing camera 1, another subscriber may be receiving video images from camera 2 and may desire to pan to camera 3. This is represented by line 824 in FIG. 8. Thus, while the composition module is interpolating originating frame 801 to target frame 802b for one subscriber, the composition module may be interpolating originating frame 802a to target frame 803b. Similarly, simultaneous transitions may be occurring for images 803a, 804a, 805a, 806a etc. Consequently, the composition module may be always interpolating any given camera feed to an adjacent camera feed. Thus, the series of parallel processing lines in FIG. 8 illustrates that parallel processing occurs. FIG. 8 shows panning in one direction, and it is possible that a user may indicate or be provided with panning in the other direction, the composition module may also be interpolating in the other direction, as shown in FIG. 9.

In this example of FIG. 9, lines 920 represents interpolating a video image from C2 to C1 during four time period. It can be noted that the transitioning in FIG. 9 does not “wrap-around.” That is, camera 1 cannot be panned to camera 7, or vice versa. However, there is no technical prohibition for doing this and other embodiments may allow wrap-around panning. For example, returning to FIG. 2, camera 7 is an end-view of the playing field, whereas camera 6 is side view of the playing field. Panning from a side-view camera to an adjacent side view camera may result in a smoother or more cognizant transition than from a side view to an end-view camera. Note that in other embodiments, the stadium could be ringed with cameras along the entire perimeter, so that that is some angular panning from one camera to another. In such an embodiment, it is possible to pan continuously from any one camera feed to another.

FIGS. 8 and 9 illustrate panning for each camera feed can occur in a simultaneous manner, and can occur for a “panning—left” direction and a “panning—right” direction. This simultaneous interpolation panning can occur every time period for every feed. However, in other embodiments, the interpolation may occur every N time periods. For example, a user may be receiving digital frames from camera N, denoted as C_{N}. It is possible that during a present time period a given user may request to pan the displayed image. In some embodiments, the interpolation may be done only every other time period, e.g., at T₁, T₃, T₅, etc. If the user requests the interpolation beginning at T₃, then the system can immediately process the user's request with the interpolation process for the appropriate camera. However, if the users requests interpolation at, e.g., T₂ the system may delay responding to the response for one time period. This would represent a delay of 1/30^{th} of a second if each time period is 1/30^{th} of a second. This delay may be imperceptible to the user, but the system as a result would be required to perform half the number of interpolation requests. Similarly, if the interpolation processing is done every third time period, then only one third of the processing occurs relative to performing interpolation for every time period.

In examining the processing that occurs, e.g., in FIG. 8, the system starts with the originating frame, such as C2ₜ₁ 802a and transforms this image to the target image of C3ₜ₄ 803b. Obviously, to transform an originating frame to a target frame requires that the target frame be known. Thus, the transformation cannot start immediately during t1, but can only occur after the t4, when the target frame has been received. If the interpolation occurs every five time periods, then the system would have to wait for the fifth time period before the transform processing can start. Consequently, the system must cache a certain number of video frames (specifically, four in the example shown in FIG. 8) before initiating the interpolation processing. This delay can be incurred on a per user basis (if the user is receiving a unicast version of the video), or can occur for all users, regardless of whether they have requested panning.

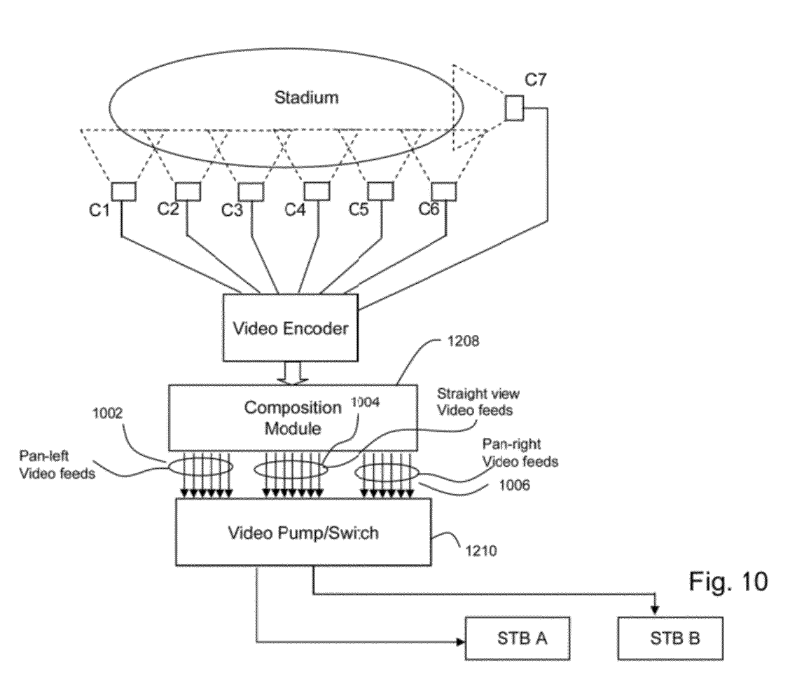

FIG. 10 illustrates how the various simultaneous interpolation images can be produced by the composition module 1208. Specifically, the figure illustrates how there can be six pan-left interpolated image streams 1002 generated, simultaneous with the seven direct camera image streams 1004, and simultaneous with the six pan-right interpolated image streams 1006. Other embodiments may have additional (or fewer) streams generated. By simultaneously generating pans for each possible camera and direction, a large number of users can be efficiently handled.

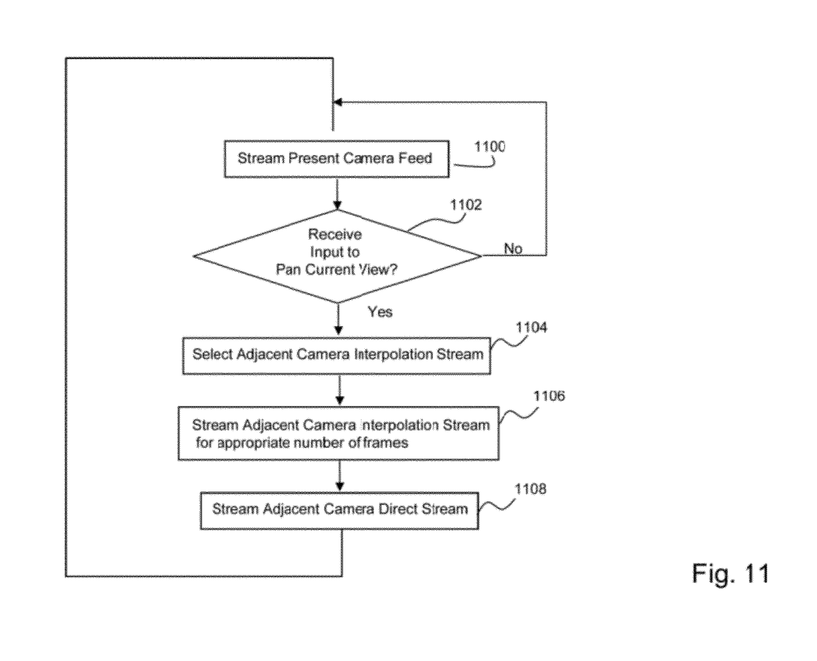

The streams are selected to the video pump/switch 1210, which then switches the appropriate stream to the users. In some embodiments a plurality of users will receive the same broadcast, which includes the panning effect, whereas in other embodiments, a single user can providing signaling messages from the set top box to the cable headend (e.g., the video pump/switch) to control which stream is selected for the user. In the latter case, the set top box is equipped with software to process user input commands indicating a direction for panning, which results in an appropriate request message generated from the set top box to the cable headend. This process is reflected in FIG. 11.

In FIG. 11, in the initial step 1100, the user receives a stream of video from a particular camera. This can be considered a “direct” feed from a particular camera, since no interpolation or modification of the frames are performed. Until a change of input or pan instruction is received in step 1102, the same stream is provided to the user at step 1100. At some point, illustrated in step 1102, input is received to pan the current view, which can be to the left or right. In some embodiments, this input can come from the user. In these instances, the video stream is typically associated with a unicast video stream. In other embodiments, the cable service provider, broadcaster, or other entity may provide the pan request for a plurality of users. The action of panning is performed in part in step 1104 by selecting an adjacent interpolated camera stream, which comprises the interpolated frames. Once the series of frames comprising the original video frame, interpolated frames, and the final (target) video frame is transmitted in step 1106, the system then switches to an provides the adjacent camera direct (unmodified) stream to the viewer in step 1108.

To summarize this process in terms of FIG. 10, the video pump/switch streams one of the direct camera feeds within the set of feeds 1004. Then for a brief time, the stream switches to one of the pan-left video feed streams 1002 or the pan-right video feed stream 1006. Once the panning is completed, then video pump/switch switches to the next adjacent camera feed from the set 1004 is streamed. In other embodiments, the switching function can be a separate function from the multiplexer, or could be integrated within the composition module. The diagram represents only one embodiment, and a number of other variations are possible.

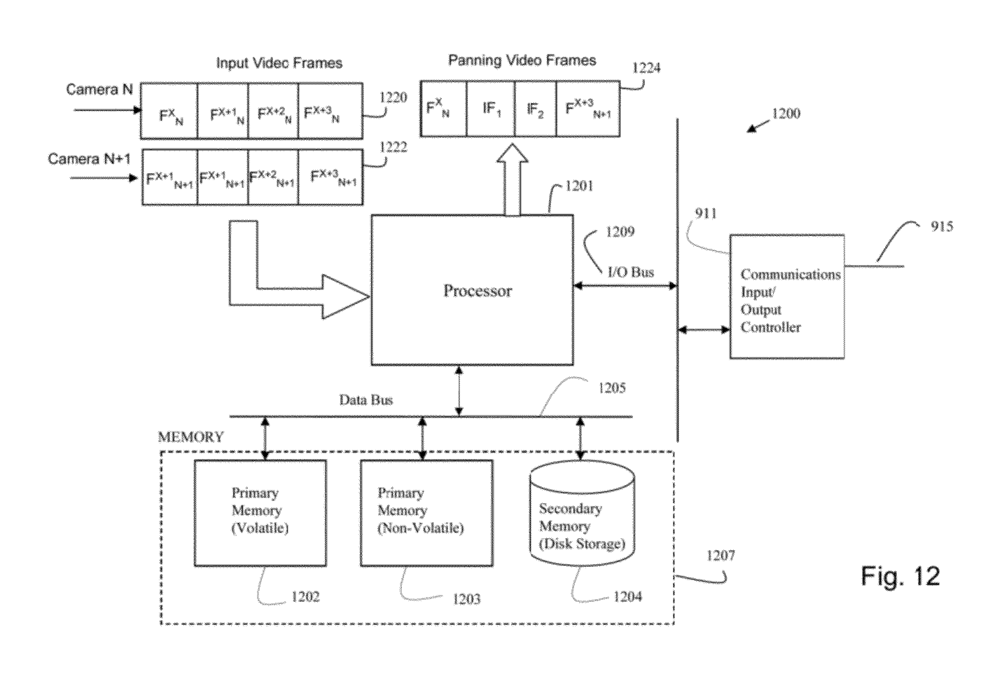

One embodiment for the composition module is shown in FIG. 12. The composition module comprises a combination of hardware executing software in one embodiment, and in another embodiment can be specialized hardware programmed or designed to perform the above functions. In this embodiment 1200, the system comprises a processor 1201 which executes programmed steps which can be stored in memory 1207, which can comprise primary (volatile) memory 1202, primary (non-volatile) memory 1203, and secondary memory 1204, which typically is a form of disk storage. A variety of technologies for storing information can be used for the memory, including RAM, ROM, EPROM, flash memory, etc.

The processor accesses a plurality of buffers, of which only two 1220, 1222 are shown. These buffers continuously receive the direct video frames from the plurality of cameras, and this figure illustrates two buffers, one for Camera N 1220 and another for Camera N+1 1222. These buffers store a number of video frames for a number of time periods, which are denoted according to their relative time period, Tₓ, Tₓ₊₁, etc. The first frame in buffer 1220 from Camera N can be denoted as F^{X}_{N}. Similarly, the first frame in buffer 1220 from Camera N+1 can be denoted as F^{X}_{N+1}. The respective frames in the buffers in the next time period can be denoted as F^{X+1}_{N} and F^{X+1}_{N+} respectively.

The processor 1201 can access these video frames in buffers 1220 as necessary. In this illustration, the processor will produce a sequence of pan video frames starting with Camera N and going to Camera N+1. The processor retrieves the first frame, F^{X}_{N} from Camera N, and then retrieves the target frame F^{X+3}_{N+1} from buffer 1222. With these two frames, the processor 1201 can then calculate the interpolated frames using the appropriate transformation algorithm, and generate the contents of the pan video frames in buffer 1224. The pan video frames in this buffer comprises the first video from Camera 1, F^{X}_{N}, followed by the two interpolated frames, denoted as Interpolated Frame 1 (“IF₁”) and Interpolated Frame 2 (“IF₂”). The target video frame is the unmodified video frame F^{X+3}_{N+1}.

Thus, the output panning video frames in the buffer 1224 are either copied from the input buffers or generated by the processor, and stored. In other embodiments, only the interpolated frames could be stored in the buffer 1224, as the originating frame and the target frame could be stored in buffers 1220 and 1222. As noted before, a variety of algorithms can be used to generate the content of the intermediate frames based on processing the contents of the originating video frame and the target video frame. The processor can then write the frames in buffer 1224 out via I/O bus 1209 to a communications I/O interface 911, which can send the data to the video pump via connection 915. Thus, the processor in conjunction with the buffers can function as a switch for selecting which frames from the input buffers are streamed to the video distribution network and also generated and stream the interpolated frames. Other forms of directly providing the buffer 1224 contents to the video pump are possible. Other embodiments may incorporate other structures for efficiently compiling the appropriate frames and streaming them.

FIG. 12 shows only a portion of the input video buffers and the pan video frame buffer 1224 that maybe deployed in a system. This may be replicated as appropriate to provide the other panning video streams discussed. In some embodiments, the composition module will have a buffer for each video input, a pan video buffer from every camera input to an adjacent camera input in a first direction, and a pan video buffer from every camera input to an adjacent camera input in another direction. It is possible that various other architectures can be used to maximize throughput of the processing system, and other architectures within the scope of the present invention are possible.

Those skilled in the art will recognize that the principles of the present invention can be applied to other embodiments. For example, in the sports venue example disclosed, the cameras are disclosed in the same plane. Thus, a stadium could be ringed with cameras surrounding the entire venue. In other embodiments, cameras may be positioned in a three dimension space (e.g., not co-planar). Thus, cameras could be located above the venue. In one embodiment, for example, the cameras could be located in a half-spherical arrangement. This would allow panning in a vertical direction, so to speak. Further, which such a three dimensional arrangement, panning in a combination of horizontal and vertical virtual panning could occur. Specifically, pitch, yaw, and roll could be virtually simulated. Such an arrangement could allow, for example, a camera view which tracks a football in the air during a pass or kickoff. This could provide the perspective to the viewer as if the camera were following the football, and providing a view from the perspective of the football, so to speak.

That which is claimed:

1. A system for processing a first plurality of digital video frames and a second plurality of digital video frames for a video service provider to stream to a viewer, comprising:
a composition module comprising:
a first buffer storing said first plurality of digital video frames associated with a first camera;
a second buffer storing said second plurality of digital video frames associated with a second camera; and
a processor configured to:
retrieve a first video frame from said first plurality of digital video frames, where said first video frame is associated with a first time period,
retrieve a second video frame from said second plurality of digital video frames, wherein said second video frame is associated with a second time period, wherein said second time period is subsequent to said first time period, wherein there are at least one or more intervening time periods between said first video frame and said second video frame,
process said first video frame and said second video frame so as to produce one or more interpolated video frames,
store said one or more interpolated video frames into a panning video buffer, and
cause said first video frame, said one or more interpolated video frames, and said second video frame to be streamed the sequence to said viewer of said video service provider.

2. The system of claim 1 further comprising:
a first camera generating a first digital video data from which said first plurality of digital video frames are generated from; and
a second camera generating a second digital video data from which said second plurality of digital video frames are generated from.

3. The system of claim 2 wherein a portion of the subject matter captured by the first camera is also captured by the second camera.

4. The system of claim 2 further comprising:
a video encoder module receiving said digital video data from said first camera and providing said first plurality of digital, video frames in MPEG based video frames.

5. The system of claim 1 wherein said one or more interpolated video frames correspond to N number of video frames associated with N number of said intervening time periods, and wherein said second video frame is associated with a N+1 time period.

6. The system of claim 2 further comprising a video switch receiving said first plurality of digital video frames, said second plurality of digital video frames, and said one or more interpolated video frames from said composition module, said video switch configured to switch from said first plurality of digital frames to said one or more interpolated video frames, and to subsequently switch from said one or more interpolated video frames to said second plurality of digital video frames.

7. The system of claim 2 further comprising a third camera, wherein said first camera, said second camera, and said third camera are positioned along a line.

8. The system of claim 7 wherein said first camera, said second camera, and said third camera are located in a sporting venue.

9. The system of claim 6 wherein said video switch is responsive to a command causing said video switch to switch from said first plurality of digital frames to said one or more interpolated video frames, and to switch from said one or more interpolated video frames to said second plurality of digital video frames.

10. The system of claim 7 further comprising a multiplexer for transmitting said first plurality of digital frames, said interpolated video frames, and to second plurality of digital video frames over a cable service provider's cable distribution network.

11. The system of claim 5 wherein said one or more interpolated video frames each incorporate a portion of the digital data from said first video frame and said second video frame.

12. A method for processing a first plurality of digital video frames and a second plurality of digital video frames comprising the steps of:
receiving said first plurality of digital video frames at a composition module associated with a first camera;
receiving said second plurality of digital video frames at the composition module associated with a second camera;
selecting a first video frame from said first plurality of digital video frames wherein said first video frame is associated with a first time period;
selecting a second frame from said second plurality of digital video frames, wherein said second frame is associated with a second time period, wherein said second time period is subsequent to said first time period;
processing said first frame and said second frame by a processor in said composition module to generate one or more interpolated video frames
storing said interpolated video frames into a panning video buffer; and
causing streaming in sequence of said first video frame, said one or more interpolated video frames, and said second video frame to be streamed over a cable distribution network.

13. The method according to claim 12 wherein a first camera generates a first digital video data from which said first plurality of digital video frames are generated, and wherein a second camera generates a second digital video data from which said second plurality of digital video frames are generated.

14. The method according to claim 13 wherein a portion of the subject matter captured by the first camera is captured by the second camera.

15. The method according to claim 14 wherein a video encoder receiving the first digital video data generates said first plurality of digital video frames comprising a first set of MPEG video frames, and said video encoder receiving the second digital video data generates said second plurality of digital video frames comprising a second set of MPEG video frames.

16. The method of claim 12 wherein there are Y number of time periods between the first video frame and said second video frame, and there are Y number of interpolated video frames.

17. The method of claim 16 wherein each of the Y number of interpolated video frames comprises a first subset of data from the first video frame and a second subset of data from the second video frame.

18. The method of claim 17 wherein a video switch performs the steps of:
switching said first plurality of digital video frames to a viewer;
switching said Y number of interpolated video frames to said viewer, and
switching at least a portion of said second plurality of digital video frames to said viewer.

19. A system for providing panning video frames to a viewer comprising:
a first memory buffer storing first MPEG video frames from a first camera, said first MPEG frames comprising a first plurality of first video frames wherein each one of said first video frames is associated with a respective time period;
a second memory buffer storing MPEG video frames from a second camera, said second MPEG frames comprising a second plurality of second video frames wherein each one of said second video frames is associated with said respective time period;
a processor configured to:
retrieve one of the first plurality of first video frames from said first memory buffer as an originating video frame,
retrieve one of the second plurality of second video frames from said second memory buffer as a target video frame, wherein said originating video frame is associated with a time period X and said target video frame is associated with a time period Y, wherein time period Y occurs Z number of time periods after time period X, and
generate Z−1 number of interpolated video frames based on said originating video frame and said target video frame;
and
a video pump configured to stream said originating video frame, said Z−1 number of interpolated video frames, and said target video frame to a viewer.

20. The system of claim 18 further comprising a plurality of cameras, wherein a first camera provides digital video data used in said originating video frame and a second camera provider digital video data used in said target video frame, and wherein at least portion of data in said originating video frame and said target video frame is in said Z−1 number of interpolated video frames.
